(19) United States
(12) Patent Application Publication
(10) Pub. No.: US 2016/0026308 A1
(43) Pub. Date: Jan. 28, 2016

(54) SMART WEARABLE DEVICE

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/734,568

(22) Filed: Jun. 9, 2015

(30) Foreign Application Priority Data
Jul. 25, 2014 (CN) 201410359760.1
Jul. 25, 2014 (CN) 201410361715.X
Aug. 4, 2014 (CN) 201410380523.3

(51) Int. Cl. G06F 3/047; G09G 5/00

(52) U.S. Cl. CPC G06F 3/047; G09G 5/003; G09G 2370/16; G09G 2300/04

(57) ABSTRACT

A smart wearable device comprises a body, a display module and at least one slide-on-strap touch-sensing structure. The display module is disposed on the body and comprises a display unit and a processing unit coupled with the display unit. The slide-on-strap touch-sensing structure is coupled with the processing unit and two slide-on-strap touch-sensing structures are disposed on the opposite sides of the display unit. The slide-on-strap touch-sensing structure senses at least one trigger event. By disposing the area of the touch input on two sides of the display unit, the image or items displayed by the display unit won't be shaded during the user's operation.

### CROSS REFERENCE TO RELATED APPLICATIONS

This Non-provisional application claims priority under 35 U.S.C. §119(a) on Patent Application No(s). 201410361715.X, 201410359760.1 and 201410380523.3 filed in People's Republic of China on Jul. 25, 2014, Jul. 25, 2014 and Aug. 4, 2014, the entire contents of which are hereby incorporated by reference.

### BACKGROUND OF THE INVENTION

1. Field of Invention

This invention relates to a wearable device and, in particular, to a smart wearable device.

2. Related Art

With the progress of technologies, various information devices having communication functions are continuously innovated, such as mobile phones, tablet computers, ultra-thin notebook computers, satellite navigation devices or the like. At present, due to advances in technology, the processors are continuously developed toward the direction of the small size and the high performance. Thus some wearable devices having the sizes much smaller than other communication devices are also developed to have communication functions and other functions.

Accordingly, smart wearable device products, such as smart watches, smart bracelets or the like, have been developed and come out. In comparison with the conventional watch, the smart watch further comprises a positioning module capable of recording a position of the smart watch and a transmission module capable of communicating with other electronic devices to obtain the activity records of the user while wearing the smart watch. Likewise, at present, a kind of bracelet device, the so-called smart bracelet, is also configured with a positioning module and a transmission module.

However, as to the smart bracelet and the smart watch, because the size is smaller, the area for displaying information is limited. Therefore, most of the smart bracelets or smart watches only have display function but no input function. Although some smart watches are configured with the touch display panel so that the user can directly operate the smart watch in a touch manner, the user's view is easily shaded by the finger during the operation because the display area of the smart watch is small, and the erroneous touch will happen therefore. However, after a long period of the touch operation on the display panel, the panel scratch problem is easily caused. As to the conventional smart bracelet, the input function is mostly achieved by the physical key. Although the physical key can reduce the erroneous touch situation, the physical key needs to be disposed on the surface of the smart bracelet or smart watch, the appearance unity of the smart bracelet or smart watch will be deteriorated.

Furthermore, the touch display panel often needs to be configured with the rare earth transparent touch-sensing layer such as ITO (indium tin oxide) so as to be kept in high transparent display performance, but since the rare earth metal indium is unceasingly consumed, the cost of the product will become higher and higher. Besides, the conductivity of the rare earth metal is worse than the normal metal, so that the detection sensitivity of the touch is limited. Therefore, using the rare earth transparent touch-sensing layer in the touch panel is not a good choice for the environmental resources and energy conservation. Moreover, the transparency of the display panel will also be reduced when the ITO transparent touch-sensing layer is formed on the display panel. In addition, even if the ITO is replaced by the metal mesh, the metal interference fringe will influence the readability of the display panel and therefore the performance and convenience of the manual operation will be reduced.

### SUMMARY OF THE INVENTION

An aspect of the invention is to provide a smart wearable device, by disposing the area of the touch input on two sides of the display unit, the image or items displayed by the display unit won't be shaded during the user's operation so that the erroneous touch situation can be avoided, the scratch problem also can be avoided, and the overall integrity and beauty of the appearance of the smart wearable device can be kept. Because the area of the touch input is disposed on two sides of the display unit, the touch display panel needn't to be applied, and therefore the rare earth transparent touch-sensing layer needn't be introduced so as to decrease the manufacturing cost. Furthermore, the metal interference fringe caused by the metal wires won't happen, so that the readability of the display panel won't be affected and the performance and convenience of the manual operation can be kept. In addition, by the definition of a specific hand gesture, the user can easily implement data transmission, so as to enhance the convenience of information sharing of Internet communities and also the overall value and function of the smart wearable device can be created.

Therefore, a smart wearable device of this invention comprises a body, a display module, a strap and at least one slide-on-strap touch-sensing structure. The display module is disposed on the body and comprises a display unit and a processing unit coupled with the display unit. The strap is disposed on a side of the display module. The slide-on-strap touch-sensing structure is disposed on the strap and coupled with the processing unit, and senses at least one trigger event.

In one embodiment, the smart wearable device comprises two slide-on-strap touch-sensing structures which are disposed on opposite sides of the display unit.

In one embodiment, the smart wearable device comprises a smart bracelet, a smart watch, a smart remote control or a smart network bridge.

In one embodiment, the slide-on-strap touch-sensing structure is disposed on a watchband of the smart watch or a strap of the smart bracelet.

In one embodiment, the trigger event comprises a trigger quantity, a trigger quantity distribution, a trigger morphology, a trigger time or a trigger frequency.

In one embodiment, the processing unit receives a signal generated by the trigger event to execute an action.

In one embodiment, the processing unit executes the action according to the trigger time, a trigger path or the trigger frequency of the trigger event.

In one embodiment, when the trigger event occurs at the slide-on-strap touch-sensing structure and the trigger time is longer than or equal to a predetermined time, the processing unit executes the action comprising booting, increasing or decreasing a volume, or increasing or decreasing a playback speed.

In one embodiment, when the trigger event occurs at the slide-on-strap touch-sensing structure and the trigger path is along a single direction, the processing unit executes the action of one-dimensional screen scrolling, and the direction of the one-dimensional screen scrolling is the same as that of the trigger path.

In one embodiment, when the trigger frequency of the trigger event conforms to an unlocking condition, the processing unit executes the action of unlocking.

In one embodiment, the smart wearable device further comprises at least one function unit, which is disposed on the body or the slide-on-strap touch-sensing structure and coupled with the processing unit. The function unit comprises at least one of a wireless transmission unit, a wireless communication unit and a wireless charging unit.

In one embodiment, the wireless transmission unit comprises an infrared module, a Bluetooth module, a ZigBee module, a radio frequency (RF) module or a near field communication (NFC) module.

In one embodiment, the wireless communication unit comprises a wireless communication chip and an antenna, the wireless communication chip is electrically connected with the processing unit, and the antenna is disposed on the body or the slide-on-strap touch-sensing structure.

In one embodiment, the function unit synchronously transmits a wireless signal and receives a wireless charging energy coming from a wireless charging device.

In one embodiment, the wireless charging energy comes from a wireless access point, a display device, a TV or a monitor.

In one embodiment, one end of the body comprises a signal port, which is used for data transmission or power transmission.

In one embodiment, the slide-on-strap touch-sensing structure comprises a driving circuit and a sensing circuit, the driving circuit is disposed on an inner part of the body, and the sensing circuit is disposed on an outer surface of the body.

In one embodiment, a part of the sensing circuit forms a protrusion on the outer surface of the body, and the body further comprises a protection layer covering the protrusion.

Moreover, a smart wearable device of this invention comprises a body, a display module, a strap and at least one slide-on-strap touch-sensing structure. The display module is disposed on the body and comprises a display unit and a processing unit coupled with the display unit. The strap is disposed on a side of the display module. The slide-on-strap touch-sensing structure disposed on the strap and coupled with the processing unit. The processing unit executes following steps of: displaying a selected data on the display unit; receiving a slide by at least one finger sensed from the slide-on-strap touch-sensing structure; and transmitting the selected data to a targeted electronic device.

In one embodiment, the steps are executed after the smart wearable device establishing a connection with the targeted electronic device by a wireless transmission unit.

In one embodiment, the slide-on-strap touch-sensing structure generates a transmission signal according to the slide by at least one finger, and the processing unit transmits the selected data to the targeted electronic device according to the transmission signal.

As mentioned above, in the smart wearable device of this invention, because the slide-on-strap touch-sensing structures disposed on the opposite sides of the display module providing users about the touch operation, so, the finger won't shade the user's view and the image or items displayed by the display module. Therefore, the erroneous touch can be decreased and the scratch problem of the display module also can be reduced. Additionally, because the element of performing the touch operation is the slide-on-strap touch-sensing structure, the conventional physical button can be replaced. Therefore, the panel scratch problem of the display unit can be reduced, and the overall integrity and beauty of the appearance of the smart wearable device can be achieved. Furthermore, the higher quality and more wonderful user experience can be implemented.

Because the slide-on-strap touch-sensing structure of the touch input is disposed on the strap, the touch display panel needn't to be applied in, and the rare earth transparent touch-sensing layer needn't be introduced so as to cost down. Furthermore, the metal interference fringe will not happen by the metal wires, so that the readability of the display panel won't be influenced and the performance and convenience of the manual operation can be kept.

In addition, by the definition of a specific hand gesture, the user can easily implement data transmission, so as to enhance overall functionality of the slide-on-strap smart device.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of a smart wearable device of the first embodiment of the invention;

FIG. 1B is a schematic diagram of a variation of the smart wearable device of the first embodiment;

FIG. 2 is a function block diagram of the display module and the slide-on-strap touch-sensing structures shown in FIG. 1B;

FIG. 3 is a schematic diagram showing the operation of the smart wearable device in FIG. 1B;

FIGS. 4A and 4B are schematic diagrams showing the operations of the smart wearable device in FIG. 1B;

FIG. 5 is a schematic diagram showing the operation of the smart wearable device in FIG. 1B;

FIG. 6 is a schematic diagram of a smart wearable device of the second embodiment of the invention;

FIG. 7 is a schematic diagram of a smart wearable device of the third embodiment of the invention;

FIGS. 8A and 8B are schematic diagrams of a smart wearable device of the fourth embodiment of the invention;

FIG. 9A is a schematic diagram of a smart wearable device of the fifth embodiment of the invention;

FIG. 9B is a schematic diagram of a variation of the smart wearable device of the fifth embodiment of the invention;

FIG. 10 is a schematic diagram of a smart wearable device of the sixth embodiment of the invention;

FIG. 11A is a schematic diagram of a smart wearable device of the seventh embodiment of the invention;

FIG. 11B is a schematic diagram of a variation of the smart wearable device of the seventh embodiment of the invention;

FIG. 12 is a function block diagram of the display module and the slide-on-strap touch-sensing structures shown in FIG. 11B;

FIG. 13 is a schematic diagram showing the operation of the smart wearable device in FIG. 11B;

FIG. 14 is a schematic flowchart of the computer-executed method of an embodiment of the invention;

FIGS. 15A and 15B are schematic diagrams showing the following operations of the smart wearable device in FIG. 13; and

FIG. 16 is a schematic diagram showing another operation of the shadeless touch smart wearable device in FIG. 11B.

### DETAILED DESCRIPTION OF THE INVENTION

The present invention will be apparent from the following detailed description, which proceeds with reference to the accompanying drawings, wherein the same references relate to the same elements.

The smart wearable device of this embodiment refers to the device that the user can directly wear, such as a smart bracelet or a smart watch. The smart wearable device of this embodiment also can be a detachable wearable device, such as a device worn in the form of a necklace. The main body of the smart wearable device not only can be the main body of the watch but also can act as a smart remote control or a smart network bridge. However, this invention is not limited thereto. Therefore, the smart wearable device of this embodiment also refers to the small-sized electronic device having the display function and interaction function. The smart wearable devices of the following embodiments are described with the smart watch and the smart bracelet serving as examples.

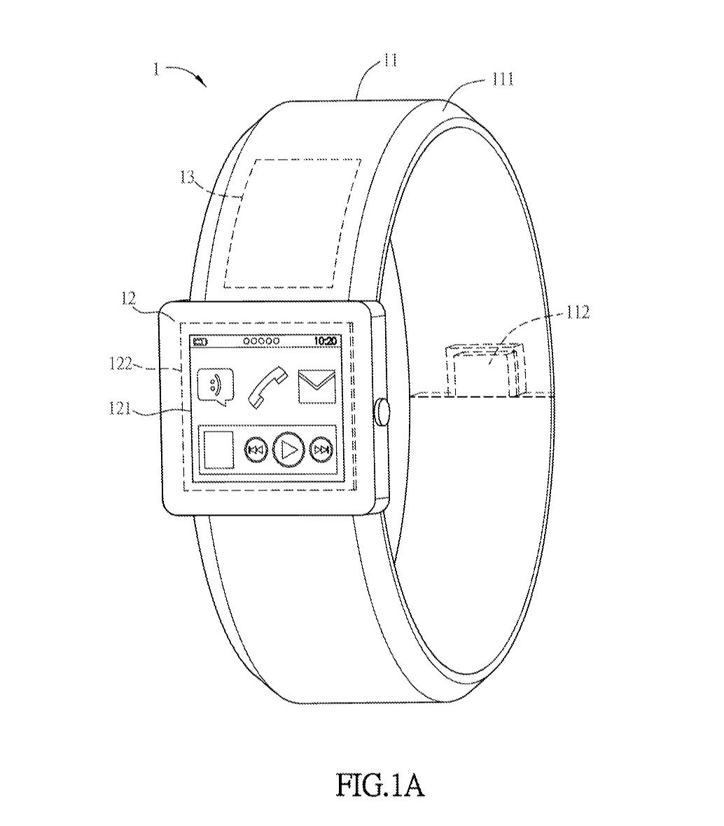

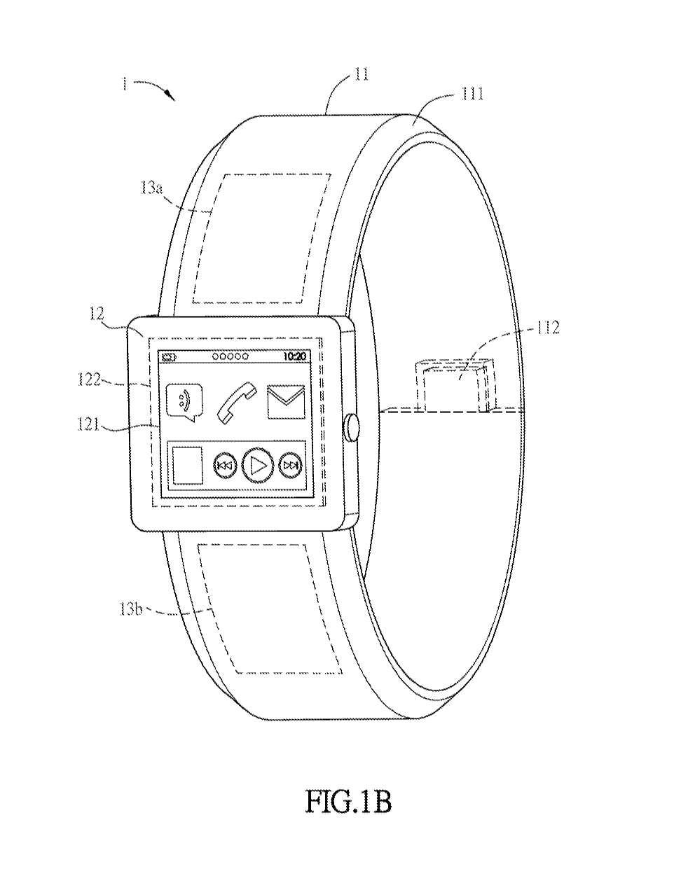

Refer to FIG. 1A, which is a schematic diagram of a smart wearable device 1 of the first embodiment of the invention. The smart wearable device 1 of this embodiment is a smart watch to be described as an example. In addition, the elements of the smart wearable device 1 of this embodiment may be implemented by the combination of the hardware, software or firmware of one or multiple signal processing and/or integrated circuits.

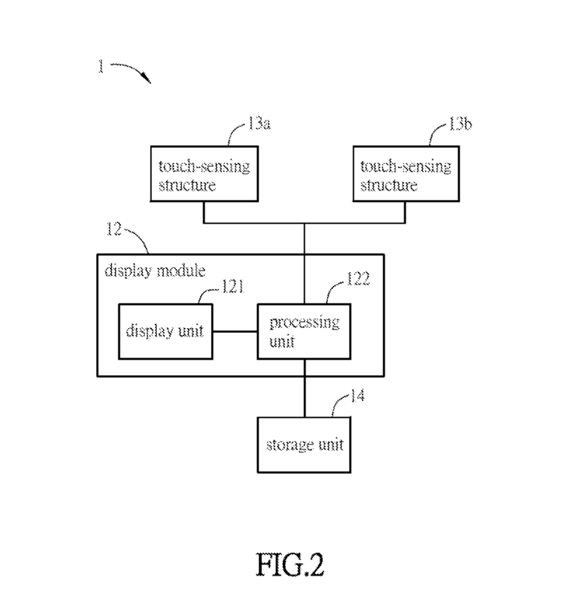

The smart wearable device 1 of this embodiment comprises a body 11, a display module 12 and at least one slide-on-strap touch-sensing structure 13. FIG. 1B is a schematic diagram of a variation of the smart wearable device of the first embodiment, wherein the smart wearable device 1 comprises two slide-on-strap touch-sensing structures 13a and 13b. The following embodiment is based on the two slide-on-strap touch-sensing structures 13a and 13b as an example. The body 11 is the portion that the user can wear and is a watchband or a strap of a bracelet in this embodiment, and can be a necklace chain in other embodiments. However, this invention is not limited thereto. The display module 12 is disposed on the body 11 and comprises a display unit 121 and a processing unit 122, as shown in FIG. 2, which is a function block diagram of the display module and the slide-on-strap touch-sensing structures shown in FIG. 1B. The processing unit 122 is coupled with the display unit 121 to control the information and image displayed by the display unit 121. In this embodiment, in addition to a normal time image, the display unit 121 also can provide a graphical user interface (GUI) for the user. The graphical user interface can comprise one or multiple figures to exhibit any kind of the known software components in the form of a figure (such as an icon). The display unit 121 is, for example but not limited to, a liquid crystal display (LCD) device, a light-emitting diode (LED) display device, an organic light-emitting diode (OLED) display device or an electronic paper (electrophoretic display device). The display unit 121 of this embodiment can be a transreflective LCD device, and its advantage is that the display unit 121 can maintain the sunlight readability under the sunlight or a strong light, which means the image displayed by the display unit 121 is still visible clearly under the strong light. Besides, when the light is sufficient, the additional illustration can be provided by reflecting the surrounding light of the smart wearable device 1, so as to achieve the effect of saving energy.

As shown in FIG. 1B, the slide-on-strap touch-sensing structures 13a and 13b are disposed on a side of the display unit 121. The slide-on-strap touch-sensing structures 13a and 13b are disposed on the opposite sides of the display unit 121. In this embodiment, the slide-on-strap touch-sensing structures 13a and 13b are respectively disposed on the upper side and lower side of the display unit 121. In other embodiments, the slide-on-strap touch-sensing structures 13a and 13b can be respectively disposed on edges 111 of the body 11 to form the embodiment where the slide-on-strap touch-sensing structures 13a and 13b are disposed on the left side and right side of the display unit 121. On the other hand, the slide-on-strap touch-sensing structures 13a and 13b can be disposed on the upper side, lower side, left side and right side of the display unit 121 so as to increase the area for the user's operation. However, this invention is not limited thereto. In this embodiment, the slide-on-strap touch-sensing structures 13a and 13b of this embodiment are capacitive touch-sensing structures. When a conductor (such as the user's finger) touches the slide-on-strap touch-sensing structures 13a and 13b, a capacitance variation will be generated at the touch position of the slide-on-strap touch-sensing structures 13a and 13b and the corresponding signal can be thus generated. Moreover, the advantage of providing the slide-on-strap touch-sensing structures 13a and 13b disposed on the opposite sides of the display unit 121 for the user's touch operation comprises that the slide-on-strap touch-sensing structures 13a and 13b needn't be made by the transparent touch-sensing material (such as ITO) for matching the display performance of the display unit 121, and therefore the material selection will be more flexible and the cost can be easily controlled. Besides, the slide-on-strap touch-sensing structures 13a and 13b can comprise a driving circuit and a sensing circuit (i.e. the so-called Tx and Rx, not shown), and the material thereof can be a conducting layer (such as a transparent conducting layer, comprising indium tin oxide (ITO), indium zinc oxide (IZO), fluorine-doped tin oxide (FTO), Al-doped ZnO, Ga-doped ZnO for example), metal nanowires, graphene or metal mesh, but this invention is not limited thereto.

The slide-on-strap touch-sensing structures 13a and 13b of this embodiment refer to that the smart wearable device 1 comprises a strap, such as a watchband of a watch or a strap of a bracelet, and the slide-on-strap touch-sensing structures 13a and 13b are disposed on the strap so that the touch input can be executed on the strap.

In one embodiment, the driving circuit is disposed on an inner part of the body 11, the sensing circuit is disposed on the outer surface of the body 11 and a part of the sensing circuit forms a protrusion on the outer surface of the body 11. The body 11 can further comprise a protection layer covering the protrusion to protect the sensing circuit. The user can know the locations of the slide-on-strap touch-sensing structures 13a and 13b by touching the protrusion. In other words, by the sensing circuit of the protrusion, the locations of the slide-on-strap touch-sensing structures 13a and 13b can be indicated. In other embodiments, the protrusion can be designed into a certain shape such as an arrowhead and also can be used for the indication of the user's touch operation.

As shown in FIG. 2, the smart wearable device 1 can further comprise a storage unit 14 acting as the storing medium of the smart wearable device 1. The storage unit 14 also can be the memory inside the smart wearable device 1 or outside the smart wearable device 1 (such as the cloud memory or cloud storage), but this invention is not limited thereto. The storage unit 14 can store the operation system, application programs, data processing programs and electronic data of various formats. The operation system is the program managing the computer hardware and software resources. The application program can be a word processing program, email program or others. In this embodiment, the storage unit 14 is coupled with the processing unit 122, and the processing unit 122 comprises a central processing unit (CPU) for example to execute the programs.

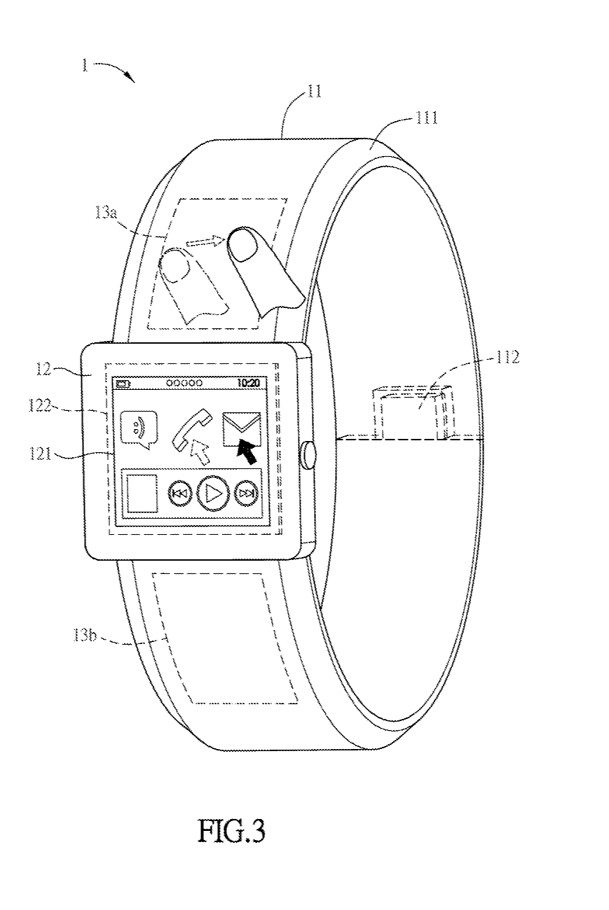

The slide-on-strap touch-sensing structures 13a and 13b are coupled with the processing unit 122. Thereby, the user can execute the touch operation on the slide-on-strap touch-sensing structures 13a and 13b by finger for example, and the display unit 121 can display the corresponding operation according to the user's operation gesture (or called the hand gesture), and thereby the user can interact with the graphical user interface displayed on the display unit 121. For example, when the user's finger slides on the slide-on-strap touch-sensing structures 13a and 13b, the display unit 121 will display a corresponding icon (such as an arrow or hand shape) while sliding correspondingly. Refer to FIG. 3, which is a schematic diagram showing the operation of the smart wearable device in FIG. 1B. Moreover, the interaction with the graphical user interface can be, for example, that the user touches the slide-on-strap touch-sensing structures 13a and 13b by the finger to execute the click, enlargement or movement. For example, when the user's finger taps the slide-on-strap touch-sensing structures 13a and 13b, the display unit 121 will execute the item which corresponds to the position information. Thereby, the item displayed by the display unit 121 can be directly controlled and executed through the slide-on-strap touch-sensing structures 13a and 13b, so the shadeless touch can be achieved. The above-mentioned touch can comprise, for example, an operation gesture or hand gesture, such as a single tap or multiple taps, a single slide or multiple slides (such as a rightward, leftward, upward or downward slide), sequential clicks by multiple fingers, or simultaneous slide by multiple fingers.

Physically, each touch action can make the slide-on-strap touch-sensing structures 13a and 13b sense at least one trigger event, and the signal induced by the trigger event is transmitted to the processing unit 122, so that the processing unit 122 can execute the analysis and process to generate a corresponding action, such as executing an action. The processing unit 122 of this embodiment can be composed of a single processing chip or multiple processing chips, and can not only control the content displayed by the display unit 121 but also analyze the trigger event sensed by the slide-on-strap touch-sensing structures 13a and 13b. The trigger event comprises a trigger quantity, a trigger quantity distribution, a trigger morphology (which can refer to trigger appearance), a trigger time or a trigger frequency. Besides, the actions of the smart wearable device 1 in response to various trigger events can be determined by factory settings and/or according to the user's usage.

The processing unit 122 can execute the action according to the trigger time, trigger path or trigger frequency of the trigger event. The trigger time refers to the time period for which the user's finger touches the slide-on-strap touch-sensing structures 13a and 13b. For example, a shorter click (which refers to a shorter trigger time) refers to the execution of the operation and a longer click (which refers to a longer trigger time) refers to the confirmation of the operation. The trigger path refers to the path along which the touch action is executed, and a certain path can be set to execute the corresponding action. The trigger frequency refers to the frequency of the touch action in a short time, and that is the frequency with which the user clicks the slide-on-strap touch-sensing structures 13a and 13b, and a certain click frequency can be set to correspond to an action. The following gives the illustrations of the embodiments.

In one embodiment, as shown in FIG. 1B, it can be set, when the trigger event occurs at the slide-on-strap touch-sensing structures 13a and 13b at the same time, which means the user touches the slide-on-strap touch-sensing structures 13a and 13b disposed on the two sides of the display unit 121 at the same time, and the touch time (trigger time) is longer than or equal to a predetermined time such as 5 seconds, the processing unit 122 executes the action of the booting. In other embodiments, as shown in FIG. 1A, it can be set, when the trigger time occurs at the slide-on-strap touch-sensing structure 13 and is longer than or equal to the predetermined time, the processing unit 122 executes the action of the booting. Therefore, the disposition of the physical key can be omitted.

In one embodiment, when the trigger event occurs at the slide-on-strap touch-sensing structure 13a or 13b and the trigger time is longer than or equal to a predetermined time such as 5 seconds the same as the above embodiment (or 1 second for example different from the above embodiment), the processing unit 122 executes the action of increasing or decreasing a volume. For example, as shown in FIG. 1B, when the user touches the slide-on-strap touch-sensing structure 13a for 1 second, the processing unit 122 executes the action of increasing a volume, and when the user touches the slide-on-strap touch-sensing structure 13b for 1 second, the processing unit 122 executes the action of decreasing a volume.

In another embodiment, the action of increasing or decreasing a volume also can be changed to the action of increasing or decreasing a playback speed. In other words, when the user touches the slide-on-strap touch-sensing structure 13a for 1 second, the playback speed is increased, and when the user touches the slide-on-strap touch-sensing structure 13b for 1 second, the playback speed is decreased. Other details can be comprehended by referring to the above illustrations.

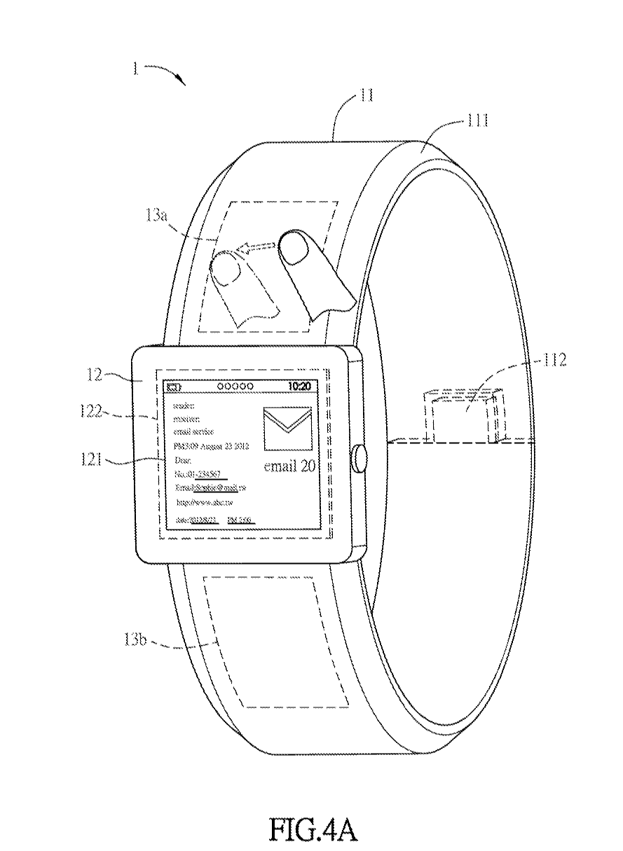

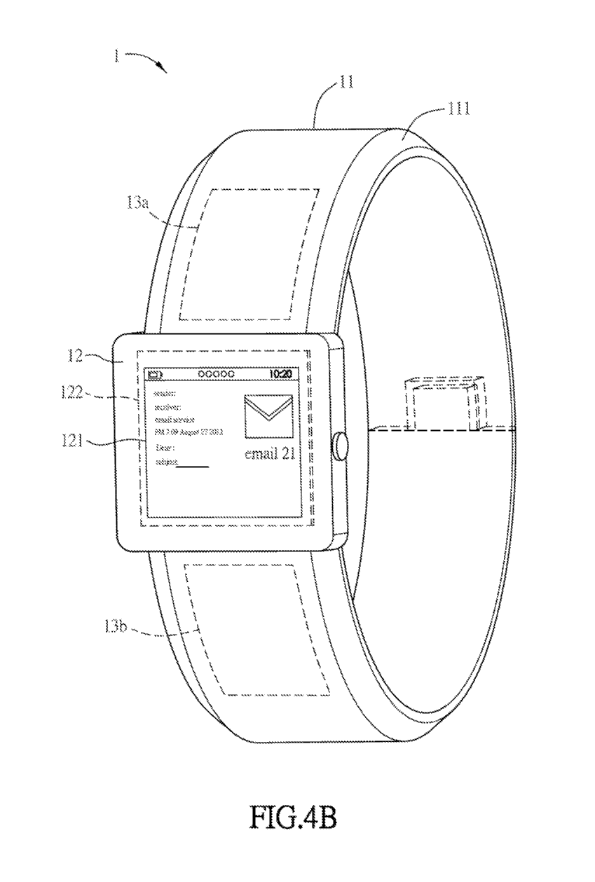

FIGS. 4A and 4B are schematic diagrams showing the operations of the smart wearable device shown in FIG. 1B. In one embodiment, it can be set, when the trigger event occurs at the slide-on-strap touch-sensing structure 13a or 13b and the trigger path is along a single direction, which means the touch path is substantially straight along a single direction as shown in FIG. 4A where the user executes a slide action from right to left on the slide-on-strap touch-sensing structure 13a, the processing unit 122 can correspondingly execute the action of one-dimensional screen scrolling to switch to the next frame. In this embodiment, the direction of one-dimensional screen scrolling is the same with the trigger path, as shown in FIG. 4B where the email 21 is moved from the right side of the display unit 121 to the whole displayed frame. In this embodiment, this type of operation manner also can be applied to the browsing of document or webpage, but this invention is not limited thereto.

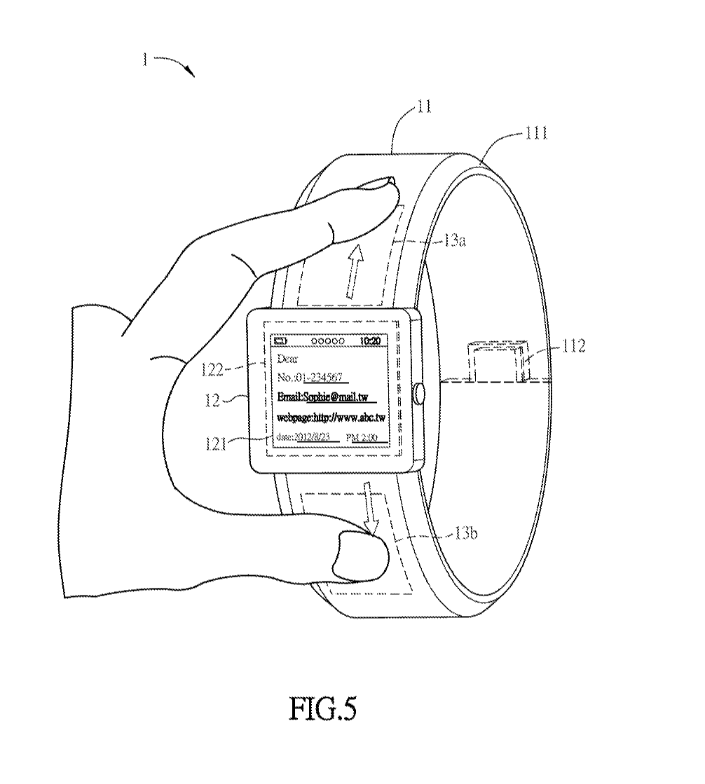

FIG. 5 is a schematic diagram showing the operation of the smart wearable device shown in FIG. 1B. As shown in FIG. 5, in one embodiment, it can be set, when the trigger event occurs at the slide-on-strap touch-sensing structures 13a and 13b at the same time and the trigger paths occurring at the slide-on-strap touch-sensing structures 13a and 13b are away from each other, the processing unit 122 executes the action of enlarging the screen (compare FIG. 4A with FIG. 5, FIG. 5 is a schematic diagram after enlarging the image displayed in FIG. 4A). On the other hand, if the trigger paths approach each other, the processing unit 122 executes the action of narrowing the screen.

In one embodiment, when the trigger event occurs at the slide-on-strap touch-sensing structures 13a and 13b at the same time and one of the trigger paths is stationary (for example, the trigger event of the slide-on-strap touch-sensing structure 13a is continuously stationary) and the other trigger path is along a single direction such as sliding from right to left, the processing unit 122 can execute the action of clockwise or counterclockwise rotation and the direction of the screen rotating is the same with the trigger path. In this embodiment, the screen rotates for ninety degrees from right to left (not shown).

In one embodiment, the trigger frequency of the trigger event conforms to an unlocking condition. That is, when the frequency with which the user clicks the slide-on-strap touch-sensing structure 13a or 13b conforms to an unlocking condition, the processing unit 122 can correspondingly execute the action of the unlocking. In other words, the user can set a certain click frequency as the unlocking condition by oneself, and when the processing unit 122 receives the trigger event that conforms to the unlocking condition, the processing unit 122 can execute the action of the unlocking to achieve the privacy protection and security effects. Besides, because the slide-on-strap touch-sensing structures 13a and 13b are disposed on the opposite sides of the display unit 121, the user's finger will not shade the image displayed by the display unit 121 when the user executes the touch input.

In other embodiments, the body 11 can be configured with a fingerprint recognition unit (not shown), so that the unlocking purpose can be achieved by the fingerprint recognition. The fingerprint recognition unit is electrically connected with the processing unit 12 and can recognize the fingerprint of at least one finger. Therefore, the user can store the fingerprint thereof in the storage unit 14 in advance, and when wanting to unlock the device, the user can touch, for example, a specific region of the slide-on-strap touch-sensing structures 13a and 13b by finger, and the processing unit 122 can compare the fingerprint in the specific region with the pre-stored fingerprint. If the fingerprints match each other, the smart wearable device 1 can be unlocked and receive the user's operation action. If the fingerprints don't match each other, the processing unit 12 will determine that the user is not a permitted user, so that the user can't execute the operation.

As shown in FIG. 1B, one end of the body 11 comprises a signal port 112, which is coupled with the processing unit 122 and can be used for data transmission and/or power transmission. Thereby, the information stored in the smart wearable device 1 can be transmitted to other electronic devices. In other embodiments, a wireless method can be used to execute the wireless charging or wireless data transmission. However, this invention is not limited thereto.

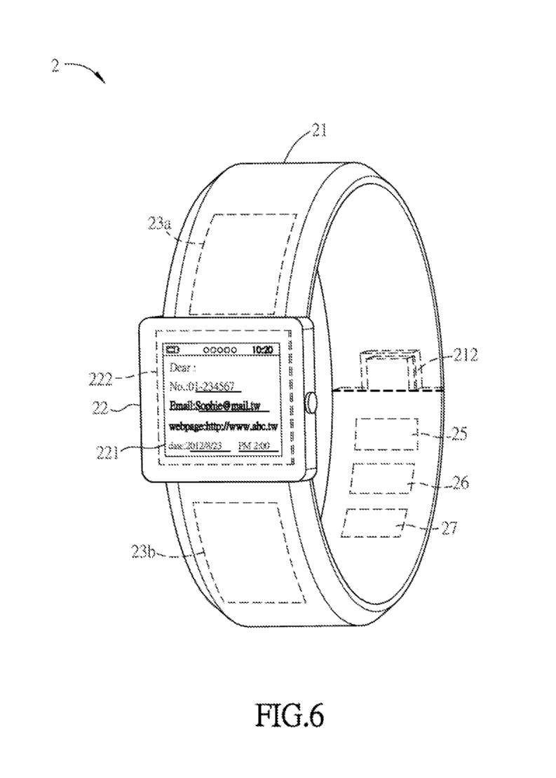

FIG. 6 is a schematic diagram of a smart wearable device 2 of the second embodiment of the invention. As shown in FIG. 6, in one embodiment, the smart wearable device 2 can further comprise at least one function unit, which is disposed on the body 21 or the slide-on-strap touch-sensing structure 23a or 23b and coupled with the processing unit 222. The function unit comprises at least one of a wireless transmission unit 25, a wireless communication unit 26 and a wireless charging unit 27.

The wireless transmission unit 25 comprises an infrared module, a Bluetooth module, a radio frequency module or a near field communication module, and the wireless transmission unit 25 of this embodiment is illustrated as a near field communication module for example. The near field communication module comprises a near field communication chip and an antenna. The near field communication chip is coupled with the processing unit 222. The antenna can be disposed on the slide-on-strap touch-sensing structure 23a and/or 23b, but this invention is not limited thereto. When the user wants to communicate with another electronic device through the near field communication (NFC), the smart wearable device 2 can be made closer to another electronic device capable of the near field communication function, so as to execute the communication of electronic data with another electronic device through the antenna and the near field communication chip. The wireless communication unit 26 has the structure mainly the same as the wireless transmission unit 25, and also comprises a wireless communication chip and an antenna. The wireless communication chip is coupled with the processing unit 222, and the antenna also can be disposed on the slide-on-strap touch-sensing structure 23a and/or 23b. The wireless transmission unit 25 is applied to a short distance data transmission with other electronic devices, and the wireless communication unit 26 is applied to a data transmission through telecommunication or network signals. In other embodiments, the combination of the function unit also can synchronously transmit a wireless signal and receive a wireless charging energy coming from a wireless charging device, and the wireless charging energy can come from a wireless access point, a display device, a TV, a monitor or the like.

The wireless charging unit 27 can be a charging circuit and disposed on the body 21, so as to achieve the wireless charging purpose. In other embodiments, the wireless charging unit 27 also can be disposed on the slide-on-strap touch-sensing structure 23a, 23b. If the slide-on-strap touch-sensing structure 23a, 23b is made by metal mesh, metal nanowires or graphene, the driving circuit and the sensing circuit of the slide-on-strap touch-sensing structure 23a, 23b can be further used to execute the wireless power transmission, such as the wireless charging.

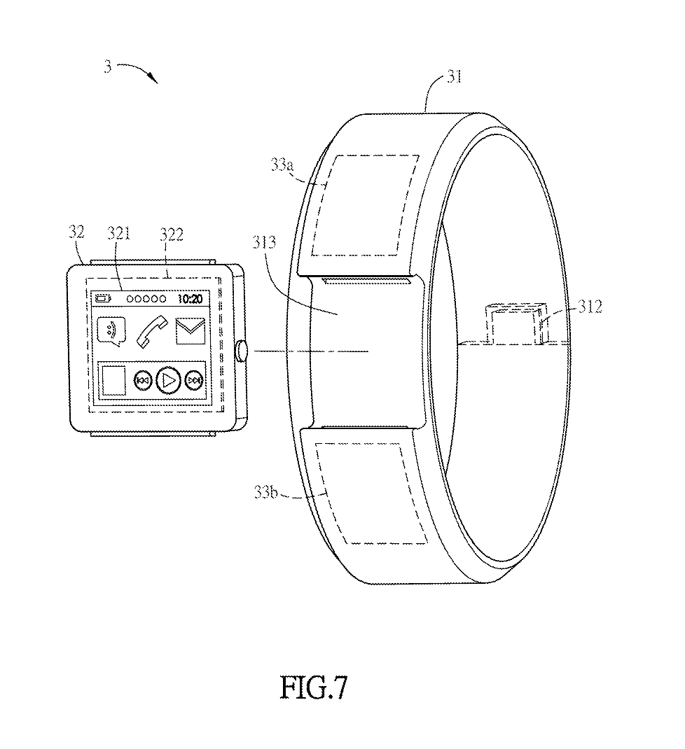

The disposition manner of the display module is not limited in this invention. In other embodiments, the display module also can be detachably disposed on the body, as shown in FIG. 7, which is a schematic diagram of a smart wearable device of the third embodiment of the invention. In this embodiment, the body 31 further comprises a depression 313, and the display module 32 can be disposed in the depression 313.

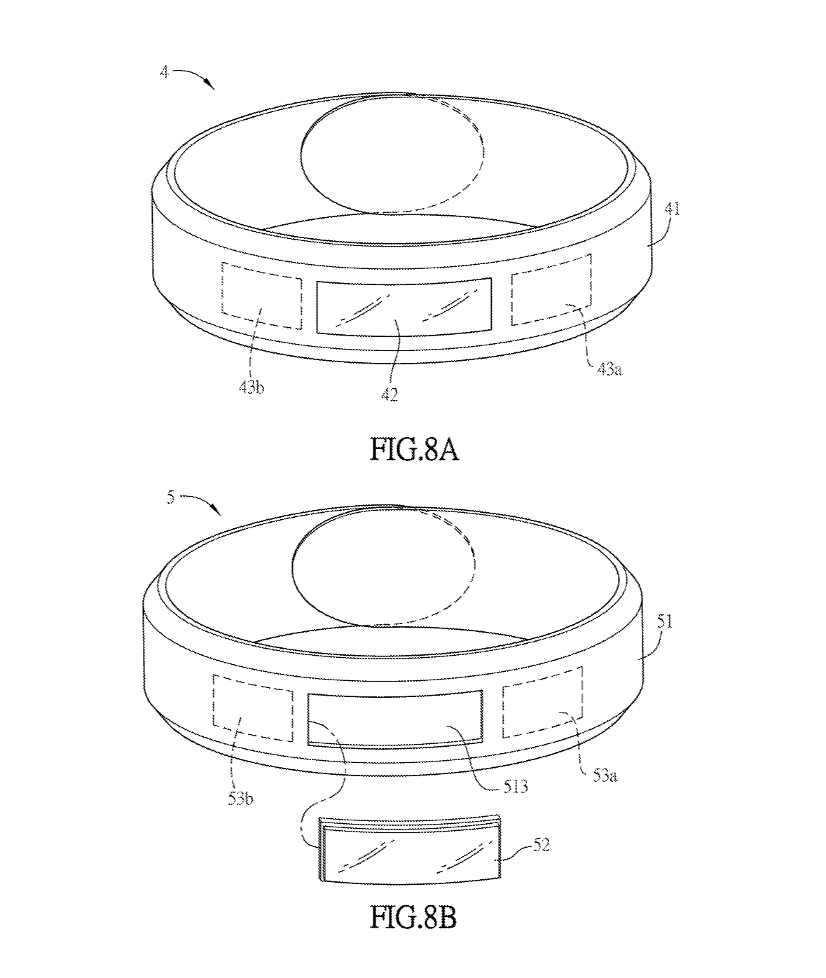

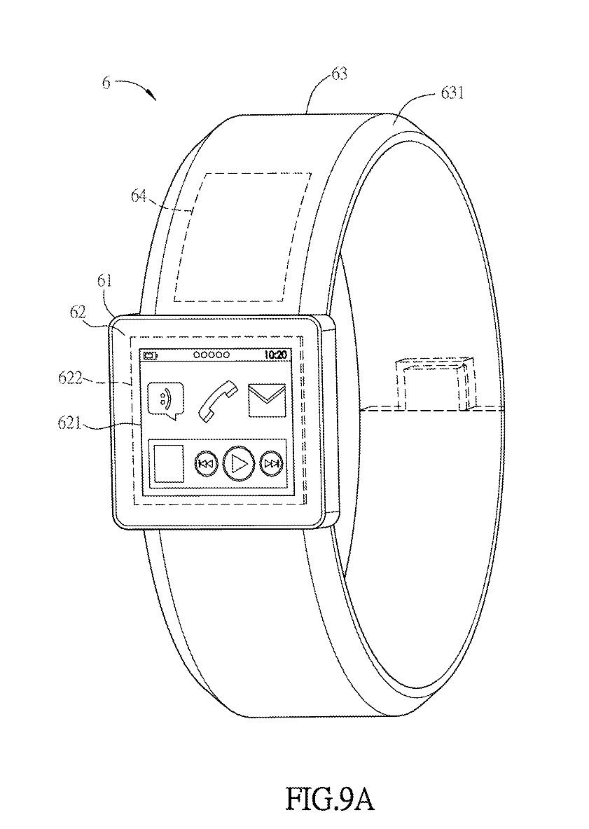

In one embodiment, the smart wearable device 4, 5 also can be applied to a smart bracelet, as shown in FIGS. 8A and 8B, which are schematic diagrams of the smart wearable devices of the fourth embodiment of the invention. As shown in FIG. 8A, the smart wearable device 4 is a smart bracelet and comprises a display module 42 disposed on the body 41. The body 41 is the strap of the smart bracelet, and the slide-on-strap touch-sensing structures 43a and 43b are disposed on the opposite sides of the display module 42. As shown in FIG. 8B, the display module 52 of the smart wearable device 5 also can be detachably disposed in the depression 513 of the body 51.

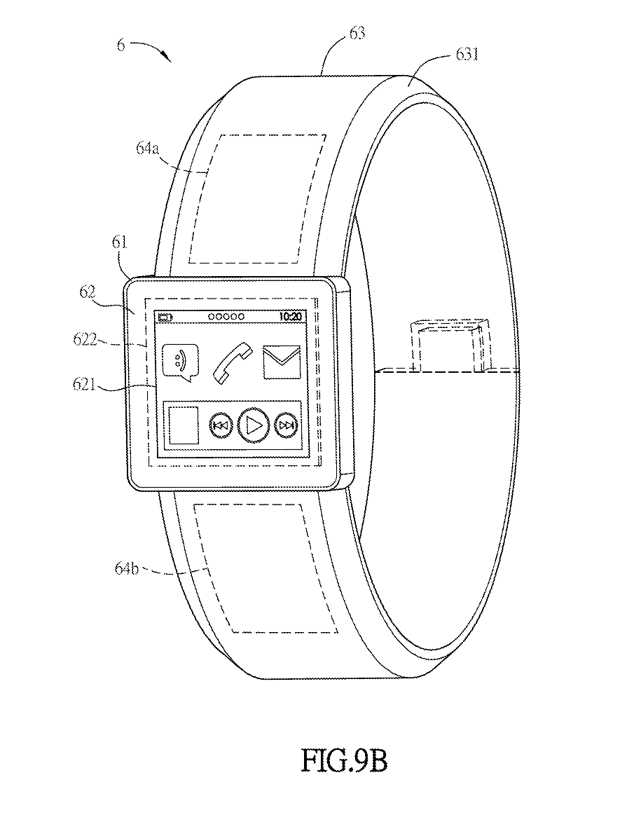

FIG. 9A is a schematic diagram of a smart wearable device of the fifth embodiment of the invention, and the smart wearable device 6 of this embodiment is illustrated as a smart watch for example. Moreover, the elements of the smart wearable device 6 of this embodiment also can be implemented by the combination of the hardware, software or firmware of one or multiple signal processing and/or integrated circuits.

The smart wearable device 6 of this embodiment comprises a body 61, a display module 62, a strap 63 and at least one slide-on-strap touch-sensing structure 64. The display module 62 and the strap 63 are disposed on the body 61, and the body 61 and the strap 63 collectively constitute the portion that the user can wear, the strap 63 of this embodiment is the watchband of the smart watch. In other embodiments, the strap 63 can be the strap of a smart bracelet or the chain of a necklace in other embodiments, but this invention is not limited thereto. The length of the strap 63 is substantially equal to that of the hand circumference or foot circumference, so that the strap 63 can be worn by the user. Moreover, the length of the strap 63 may also be adjustable so that the adjustment can be made according to the hand circumferences or foot circumferences of different users. In this embodiment, the strap 63 is disposed on a side of the display module 62 and the slide-on-strap touch-sensing structure 64 is disposed on the strap 63, to form the embodiment where the slide-on-strap touch-sensing structure 64 is disposed on a side of the display module 62.

FIG. 9B is a schematic diagram of a variation of the smart wearable device of the fifth embodiment of the invention, wherein the smart wearable device 6 of this embodiment comprises two slide-on-strap touch-sensing structures 64a and 64b. The following embodiments are illustrated by taking the smart wearable device 6 (as shown in FIG. 9B) comprising two slide-on-strap touch-sensing structures 64a and 64b as an example.

As to the display module 62, the display module 12 of the first embodiment can be regarded as a reference. Likewise, the display module 62 also comprises a display unit 621 and a processing unit 622. The processing unit 622 is coupled with the display unit 621 to control the information and image exhibited by the display unit 621. The slide-on-strap touch-sensing structure 64 (64a, 64b) is coupled with the processing unit 622. The processing unit 622 can receive the signal which is generated when the slide-on-strap touch-sensing structure 64 (64a, 64b) is touched for the input, and generate the corresponding action, wherein the operational details can be comprehended by referring to the above embodiments. The material and structure of the slide-on-strap touch-sensing structure 64a, 64b of this embodiment also can be comprehended by referring to the slide-on-strap touch-sensing structure 13a, 13b of the first embodiment.

As shown in FIG. 9A, the slide-on-strap touch-sensing structure 64 can be disposed on a side of the display unit 621. As shown in FIG. 9B, the smart wearable device 6 of this embodiment can comprise two slide-on-strap touch-sensing structures 64a and 64b, which are disposed on the opposite sides of the display unit 121 on the strap 63. The slide-on-strap touch-sensing structures 64a and 64b of this embodiment are disposed respectively on the upper side and lower side of the display unit 621. In other embodiments, the slide-on-strap touch-sensing structures 64a and 64b can be respectively disposed on edges 631 of the strap 63 to form the embodiment where the slide-on-strap touch-sensing structures 64a and 64b are disposed on the left side and right side of the display unit 621. In other words, the slide-on-strap touch-sensing structures 64a and 64b can be disposed on the upper side, lower side, left side and right side of the display unit 621, so as to increase the area for the user's operation. However, this invention is not limited thereto.

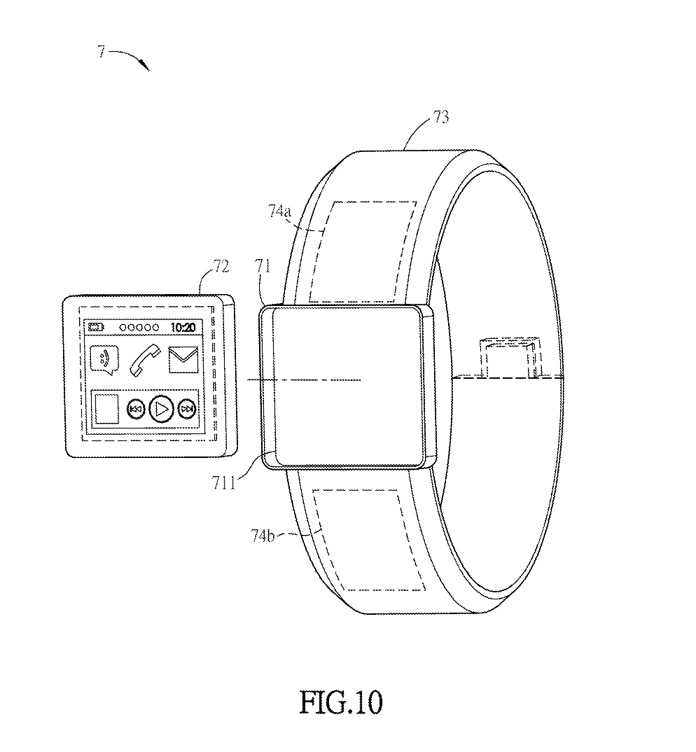

The disposition manner of the display module is not limited in this invention. In other embodiments, the display module 72 also can be detachably disposed on the body 71, as shown in FIG. 10, which is a schematic diagram of a smart wearable device 7 of another embodiment of the invention. In this embodiment, the body 71 further comprises a depression 711, and the display module 72 can be disposed in the depression 711. Besides, the slide-on-strap touch-sensing structures 74a and 74b are disposed on the opposite sides of the body 71 and display module 72 on the strap 73.

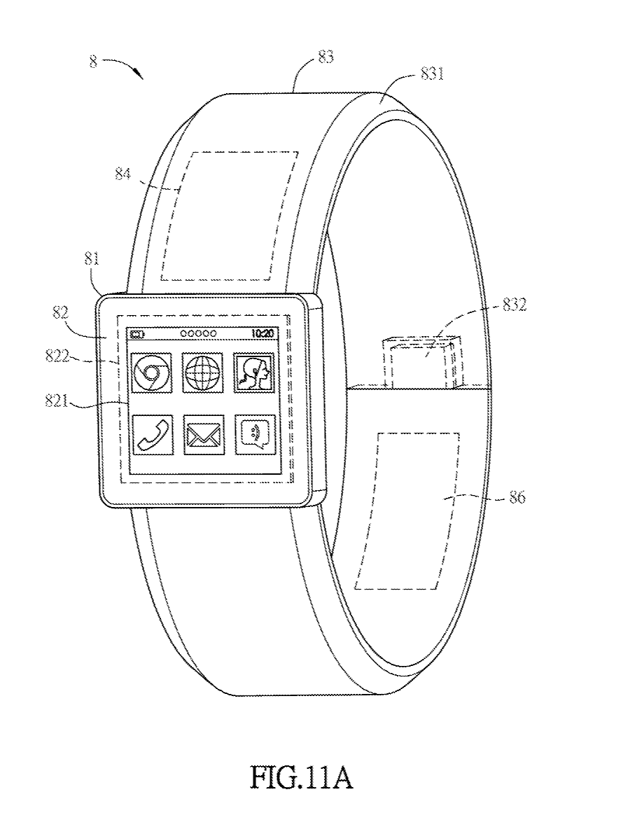

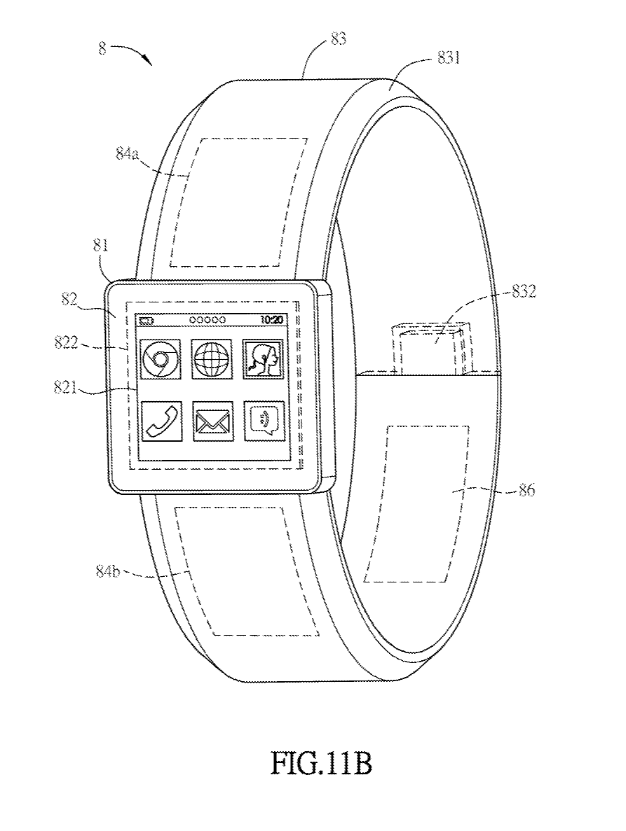

FIG. 11A is a schematic diagram of a smart wearable device of the seventh embodiment of the invention. As shown in FIG. 11A, the smart wearable device 8 of this embodiment is illustrated as a smart watch for example. In addition, the elements of the smart wearable device 8 of this embodiment may be implemented by the combination of the hardware, software or firmware of one or multiple signal processing and/or integrated circuits. The smart wearable device 8 of this embodiment comprises a body 81, a display module 82, a strap 83 and at least one slide-on-strap touch-sensing structure 84. The display module 82 and the strap 83 are disposed on the body 81, and the body 81 and the strap 83 collectively constitute the portion that the user can wear. The strap 83 of this embodiment is the watchband of a smart watch. In this embodiment, the strap 83 is disposed on a side of the display module 82 and the slide-on-strap touch-sensing structure 84 is disposed on a strap 83, to form the embodiment where the slide-on-strap touch-sensing structure 84 is disposed on a side of the display module 82.

FIG. 11B is a schematic diagram of a variation of the smart wearable device of the seventh embodiment of the invention, wherein the smart wearable device 8 of this embodiment comprises two slide-on-strap touch-sensing structures 84a and 84b. The following embodiments are illustrated by taking the smart wearable device 8 (as shown in FIG. 11B) comprising two slide-on-strap touch-sensing structures 84a and 84b as an example.

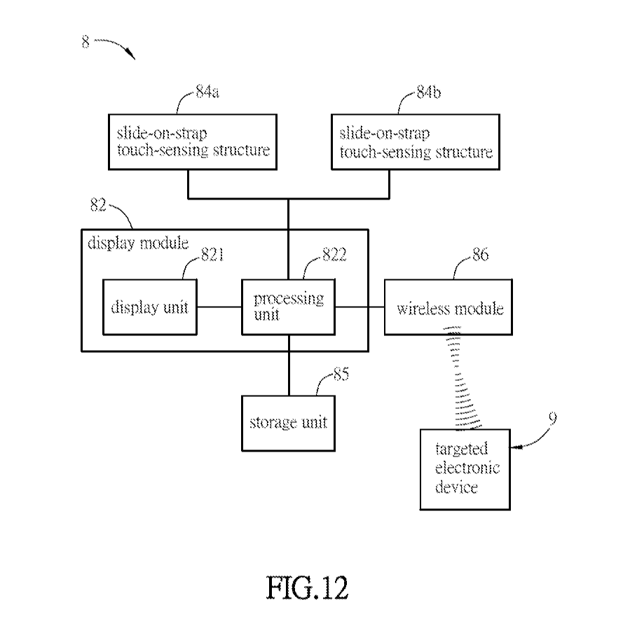

FIG. 12 is a function block diagram of the display module and the slide-on-strap touch-sensing structures shown in FIG. 11B. As shown in FIG. 12, the display module 82 comprises a display unit 821 and a processing unit 822. The processing unit 822 is coupled with the display unit 821 to control the information and image displayed by the display unit 821. The slide-on-strap touch-sensing structure 84 (84a, 84b) is coupled with the processing unit 822. The processing unit 822 can receive the transmission signal generated when the slide-on-strap touch-sensing structure 84 (84a, 84b) is touched for the input, and can generate the corresponding action, so as to execute the communication or the data transmission with other electronic devices, and the related operations will be illustrated later. The elements and structure of the display unit 821 of this embodiment can be comprehended by referring to the display unit 121 of the first embodiment, so the related illustrations are omitted here for conciseness.

As shown in FIG. 11A, the slide-on-strap touch-sensing structure 84 can be disposed on a side of the display unit 821. Favorably, as shown in FIG. 11B, the smart wearable device 8 of this embodiment can comprise two slide-on-strap touch-sensing structures 84a and 84b, which are respectively disposed on the opposite sides of the display unit 821 on the strap 83. In other embodiments, the slide-on-strap touch-sensing structures 84a and 84b can be respectively disposed on edges 831 of the strap 83 to increase the area for the user's operation. However, this invention is not limited thereto. The material and structure of the slide-on-strap touch-sensing structures 84a and 84b of this embodiment also can be comprehended by referring to the slide-on-strap touch-sensing structures 13a and 13b of the first embodiment.

As shown in FIG. 12, the smart wearable device 8 can further comprise a storage unit 85 acting as the storing medium of the smart wearable device 8. The storage unit 85 can store the operation system, application programs, data processing programs and electronic data of various formats. In this embodiment, the storage unit 85 is coupled with the processing unit 822, and the processing unit 822 comprises a central processing unit (CPU) for example to execute the programs and the computer-executed method of one embodiment of the invention.

The slide-on-strap touch-sensing structures 84a and 84b are coupled with the processing unit 822. Thereby, the user can execute the touch operation on the slide-on-strap touch-sensing structures 84a and 84b by finger for example, and the display unit 821 can display the corresponding operation according to the user's operation gesture (or called the hand gesture), and thereby the user can interact with the graphical user interface displayed on the display unit 821. Each touch action can make the sensing of the slide-on-strap touch-sensing structures 84a and 84b, and then a transmission signal is induced and transmitted to the processing unit 822. The processing unit 822 of this embodiment can be composed of a single processing chip or multiple processing chips, and can not only control the content displayed by the display unit 821 but also analyze the transmission signal, and then generate the corresponding operation, such as executing the computer-executed method of one embodiment of the invention.

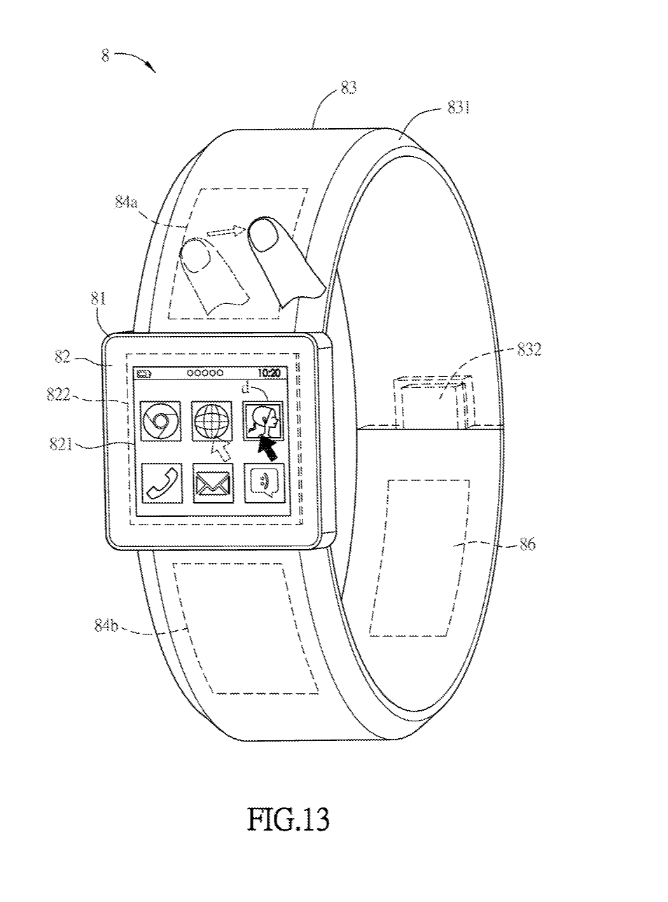

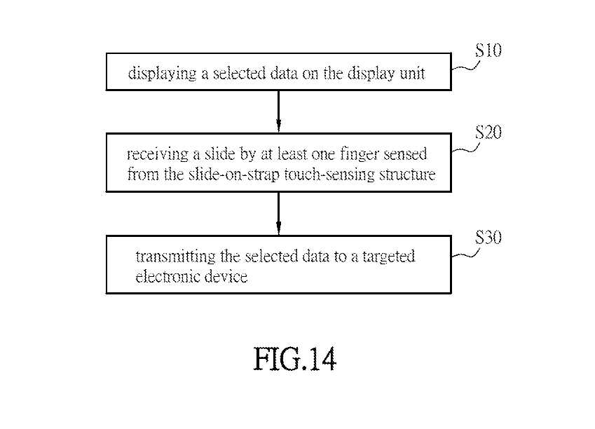

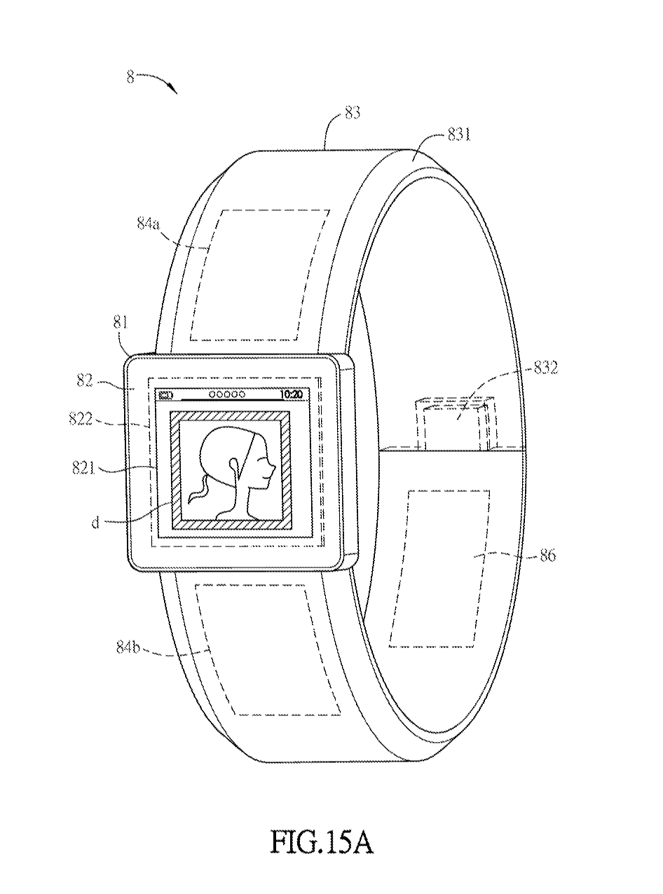

FIG. 14 is a schematic flowchart of the computer-executed method of an embodiment of the invention. As shown in FIGS. 12 and 14, the computer-executed method of this embodiment executes, on the smart wearable device 8, the following steps of: displaying a selected data on the display unit (step S10); receiving a slide by at least one finger sensed from the slide-on-strap touch-sensing structure (step S20); and transmitting the selected data to a targeted electronic device (step S30). Therefore, the user can transmit the selected data d (as shown in FIG. 13) of the smart wearable device 8 to a targeted electronic device 9. Herein, the targeted electronic device 9 is the electronic device which is able to communicate with the smart wearable device 8. The targeted electronic device 9 can be any kind of electronic device having communication function, and can be a smart mobile phone or a smart wearable device which is the same as or different from the smart wearable device 8. The targeted electronic device 9 of this embodiment is illustrated as a smart mobile phone for example.

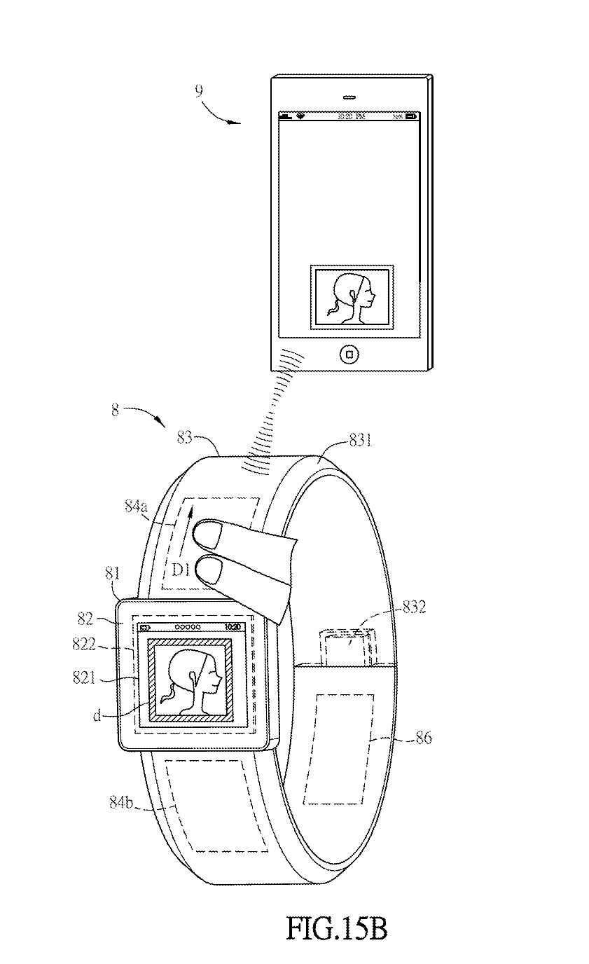

In the step S10, the user can execute an input on the slide-on-strap touch-sensing structure 84a (or on the slide-on-strap touch-sensing structure 84b, and in this embodiment the input is executed on the slide-on-strap touch-sensing structure 84a for example) to select the data that is to be transmitted to the targeted electronic device 9, which can refer to FIG. 13. The user selects the picture by a sliding on the slide-on-strap touch-sensing structure 84a and then a click (or a longer click), and the selected picture is the selected data d. Then, the display unit 821 will display the selected data d, as shown in FIG. 15A, wherein FIGS. 15A and 15B are schematic diagrams showing the following operations of the smart wearable device in FIG. 13.

As shown in FIGS. 12 and 15B, in the step S20, the user uses at least one finger to slide on the slide-on-strap touch-sensing structure 84a, and this embodiment is illustrated as two fingers sliding on the slide-on-strap touch-sensing structure 84a (double-finger sliding) for example. Thereby, the selected data d can be transmitted to the targeted electronic device 9 (step S30). In some embodiments, the smart wearable device 8 can further comprise a wireless transmission unit 86, which is electrically connected with the processing unit 822. The wireless transmission unit 86 comprises an infrared module, a Bluetooth module, a ZigBee module, a radio frequency module or a near field communication module. In a practical application, the targeted electronic device 9 can comprise another wireless transmission unit, which corresponds to the wireless transmission unit 86 of the smart wearable device 8. The smart wearable device 8 can communicates with another wireless transmission unit of the targeted electronic device 9 through the wireless transmission unit 86 and transmit the selected data d to the targeted electronic device 9 through the wireless transmission unit 86. After the smart wearable device establishing the connection with the targeted electronic device 9 by the wireless transmission unit 86, the processing unit 822 executes the multiple steps shown in FIG. 14.

In one embodiment, the user makes the smart wearable device 8 face the targeted electronic device 9 and uses two fingers to execute a double-finger sliding on the slide-on-strap touch-sensing structure 84a along the direction D1 which is relative to the targeted electronic device 9 and the smart wearable device 8. Thereby, the selected data d can be transmitted to the targeted electronic device 9 from the smart wearable device 8 and displayed by the panel of the targeted electronic device 9. The slide-on-strap touch-sensing structure 84a can sense the sliding direction or sliding angle of the double-finger input and generate a transmission signal according to the sliding direction or the sliding angle. Herein, the sliding direction refers to the direction relative to the targeted electronic device 9 and the smart wearable device 8, and the sliding angle refers to the angle relative to the targeted electronic device 9 and the smart wearable device 8. After receiving the transmission signal, the processing unit 822 can transmit the selected data d to the targeted electronic device 9 which corresponds to the sliding direction information or sliding angle information according to the sliding direction information or sliding angle information which is comprised in the processing unit 822. For more facilitating the practical application, in some embodiments, a tolerance may be allowed to exist between the sliding direction or angle of the finger and the direction or angle which is relative to the targeted electronic device 9 and the smart wearable device 8. That is, when the error therebetween is within the tolerance, the selected data d is allowed to be transmitted to the targeted electronic device 9 from the smart wearable device 8.

The selected data d which to be transmitted to the targeted electronic device 9 comprises numerals, characters, image data, audio data or other various digital data. In FIGS. 15A and 15B, the shown selected data d is illustrated as a picture stored in the smart wearable device 8 for example, but this invention is not limited thereto.

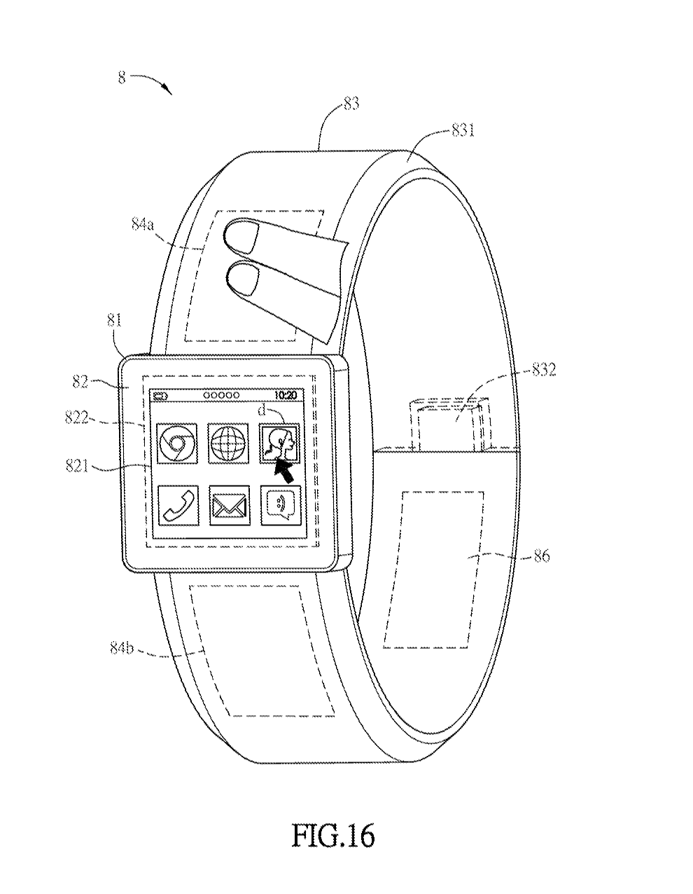

In other embodiments, the operation manner of selecting data in the step S10 also can be a double-finger selection, as shown in FIG. 16, which is a schematic diagram showing another operation of the shadeless touch smart wearable device in FIG. 11B. The selection manner shown in FIG. 16 is a double-finger selection. In detail, the user uses two fingers (especially the middle finger and the forefinger) of one hand on the slide-on-strap touch-sensing structure 84a to select the picture by a double-finger click, and the selected picture is the selected data d. In other embodiments, the smart wearable device 8 can further comprise an eyeball tracking module, such as an eye tracking device, a video recording device or an infrared detecting device. The eyeball tracking module can track the eyeball information of the user. Therefore, the user also can select the data displayed by the display unit 821 through the eyeball tracking module. However, this invention is not limited thereto.

Accordingly, this invention provides a novel content whereby the data can be transmitted between the devices, and especially, the user can transmit the selected data to the targeted electronic device just by using two fingers of the hand holding the smart wearable device to do a sliding on the slide-on-strap touch-sensing structure. Therefore, the user needn't use two hands at the same time, and because the double-finger sliding is executed on the slide-on-strap touch-sensing structure, the finger can be prevented from shading the image.

In one embodiment, if the wireless transmission unit 86 of the smart wearable device 8 is the near field communication (NFC) module, the near field communication module can further comprise a user identification key, and the user identification key can be automatically linked to the targeted electronic device 9 through the wireless transmission unit 86 for the purpose of restricting or managing the user, who operates the targeted electronic device 9 (who also can own the smart wearable device 8). In a practical application, the near field communication module comprises a near field communication chip and an antenna. The near field communication chip is electrically connected with the processing unit 822. The antenna can be disposed on the body 81 or the slide-on-strap touch-sensing structure 84a and/or 84b, but this invention is not limited thereto. When the user wants to execute a near field communication with the targeted electronic device 9 by the smart wearable device 8, the smart wearable device 8 can be made closer to the targeted electronic device 9 capable of the near field communication function, so as to execute the communication of electronic data with the targeted electronic device 9 through the antenna and the near field communication chip.

As shown in FIG. 11B, one end of the strap 83 comprises a signal port 832, which is coupled with the processing unit 822 and can be used for data transmission and/or power transmission. In other embodiments, a wireless method can be used to execute the wireless charging. However, this invention is not limited thereto. In other embodiments, the smart wearable device also can be applied to a smart remote control, and other electronic devices can be controlled by the smart wearable device (the smart remote control). In other words, controlling other electronic devices can be achieved by executing the touch input on the slide-on-strap touch-sensing structure. For example, by the operation on the slide-on-strap touch-sensing structure, the channel selection or the volume of TV can be controlled, or the air conditioner can be controlled. In other embodiments, the smart wearable device also can be applied to a smart network bridge, wherein the bridge of the smart wearable device (smart bridge) can be used to start other devices or networks, such as car door, entrance or factory equipment, to carry out the bridge network required for the Internet of Things (IoT) and smart life.

Summarily, in the smart wearable device of this invention, because the slide-on-strap touch-sensing structures provided for the touch operation of the user are disposed on the opposite sides of the display module, the finger won't shade the user's view and the image or items displayed by the display module. Therefore, the erroneous touch can be decreased and the scratch problem of the display module also can be reduced. Besides, because the element of performing the touch operation is the slide-on-strap touch-sensing structure, the conventional physical button can be replaced, and the overall integrity and beauty of the appearance of the smart wearable device can be maintained, and the high-quality and wonderful user experience can be implemented.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A smart wearable device, comprising:
a body;
a display module disposed on the body and comprising:
a display unit;
a processing unit coupled with the display unit; and
at least one slide-on-strap touch-sensing structure coupled with the processing unit, disposed on at least one side of the display unit and sensing at least one trigger event.

2. The smart wearable device as recited in claim 1, comprising two slide-on-strap touch-sensing structures which are disposed on opposite sides of the display unit.

3. The smart wearable device as recited in claim 1, comprising a smart bracelet, a smart watch, a smart remote control or a smart network bridge.

4. The smart wearable device as recited in claim 3, wherein the slide-on-strap touch-sensing structure is disposed on a watchband of the smart watch or a strap of the smart bracelet.

5. The smart wearable device as recited in claim 1, wherein the trigger event comprises a trigger quantity, a trigger quantity distribution, a trigger morphology, a trigger time or a trigger frequency.

6. The smart wearable device as recited in claim 1, wherein the processing unit receives a signal generated by the trigger event to execute an action.

7. The smart wearable device as recited in claim 6, wherein when the trigger event occurs at the slide-on-strap touch-sensing structure and the trigger time is longer than or equal to a predetermined time, the processing unit executes the action comprising booting, increasing or decreasing a volume, or increasing or decreasing a playback speed.

8. The smart wearable device as recited in claim 6, wherein when the trigger event occurs at the slide-on-strap touch-sensing structure and a trigger path is along a single direction, the processing unit executes the action of one-dimensional screen scrolling, and the direction of the one-dimensional screen scrolling is the same with the trigger path.

9. The smart wearable device as recited in claim 6, wherein when the trigger frequency of the trigger event conforms to an unlocking condition, the processing unit executes the action of unlocking.

10. The smart wearable device as recited in claim 1, further comprising:
at least one function unit disposed on the body or the slide-on-strap touch-sensing structure and coupled with the processing unit, and comprising at least one of a wireless transmission unit, a wireless communication unit and a wireless charging unit.

11. The smart wearable device as recited in claim 10, wherein the wireless transmission unit comprises an infrared module, a Bluetooth module, a ZigBee module, a radio frequency module or a near field communication module.

12. The smart wearable device as recited in claim 11, wherein the wireless communication unit comprises a wireless communication chip and an antenna, the wireless communication chip is electrically connected with the processing unit, and the antenna is disposed on the body or the slide-on-strap touch-sensing structure.

13. The smart wearable device as recited in claim 12, wherein the function unit synchronously transmits a wireless signal and receives a wireless charging energy coming from a wireless charging device.

14. The smart wearable device as recited in claim 13, wherein the wireless charging energy comes from a wireless access point, a display device, a TV or a monitor.

15. The smart wearable device as recited in claim 1, wherein one end of the body comprises a signal port, which is used for data transmission or power transmission.

16. The smart wearable device as recited in claim 1, wherein the slide-on-strap touch-sensing structure comprises a driving circuit and a sensing circuit, the driving circuit is disposed on an inner part of the body, and the sensing circuit is disposed on an outer surface of the body.

17. The smart wearable device as recited in claim 16, wherein a part of the sensing circuit forms a protrusion on the outer surface of the body, and the body further comprises a protection layer covering the protrusion.

18. A smart wearable device, comprising:
a body;
a display module disposed on the body and comprising:
a display unit;
a processing unit coupled with the display unit;
a strap disposed on a side of the display module; and
at least one slide-on-strap touch-sensing structure disposed on the strap and coupled with the processing unit, wherein the processing unit executes following steps of:
displaying a selected data on the display unit;
receiving a slide by at least one finger sensed from the slide-on-strap touch-sensing structure; and
transmitting the selected data to a targeted electronic device.

19. The smart wearable device as recited in claim 18, wherein the steps are executed after the smart wearable device establishes a connection with the targeted electronic device by a wireless transmission unit.

20. The smart wearable device as recited in claim 18, wherein the slide-on-strap touch-sensing structure generates a transmission signal according to the slide by at least one finger, and the processing unit transmits the selected data to the targeted electronic device according to the transmission signal.
